(19) United States
(12) Patent Application Publication
(10) Pub. No.: US 2011/0171536 A1
(43) Pub. Date: Jul. 14, 2011

(54) Electrochemical Device

(75) Inventors: Hideki Oki, Kanagawa (JP); Yuri Nakayama, Kanagawa (JP); Kazuhiro Noda, Kanagawa (JP)

(73) Assignee: Sony Corporation, Tokyo (JP)

(21) Appl. No.: 12/085,723

(22) PCT Filed: Nov. 14, 2006
(86) PCT No.: PCT/JP2006/322651

§ 371 Date: Mar. 3, 2010

(30) Foreign Application Priority Data
Dec. 2, 2005 (JP) 2005-348855

(51) Int. Cl. H01M 10/056; H01M 4/58; H01M 4/38; H01M 4/62

(52) U.S. Cl. 429/304; 429/231.6; 429/231.5; 429/224; 429/221; 429/218.1; 429/223; 429/220; 429/229; 429/217

(57) ABSTRACT

A cathode (1) is formed by compression bonding a mixture to a cathode current collecting net (5). The mixture includes a cathode active material and an electroconductive material such as graphite powder. The cathode active material is a halide of at least one metal element selected from the group consisting of Sc, Ti, V, Cr, Mn, Fe, Co, Ni, Cu, and Zn. An anode (2) is composed typically of a metallic magnesium plate. A separator (3) composed typically of polyethylene glycol is arranged between the cathode (1) and the anode (2) to avoid direct contact between them. A battery chamber (8) is filled with an electrolytic solution (4) and is hermetically sealed with a gasket (9). The electrolytic solution (4) may be a solution of a suitable metal ion-containing salt in an aprotic organic solvent, such as a solution of Mg(ACl₂EtBu)₂ in tetrahydrofuran (THF). This configuration can provide an electrochemical device that can satisfactorily bring out excellent properties, as an anode active material, such as a large energy capacity, possessed by a polyvalent metal such as metallic magnesium.

### TECHNICAL FIELD

The present invention relates to electrochemical devices such as magnesium batteries.

### BACKGROUND ART

Recently, as small electronic equipment comes down in size and weight and becomes portable for better convenience, demands are increasingly made to reduce size, weight, and thickness of batteries for use in equipment of this type.

Much has been reported about researches into a lithium secondary battery because elementary lithium (Li) has a larger energy capacity per unit weight than other elements. However, the lithium secondary battery has a problem in safety, and material lithium is limited in resources and is expensive.

In contrast, magnesium is abundant in resources and is much more inexpensive than lithium. In addition, metallic magnesium shows a large energy capacity per unit volume and is expected to be highly safe when used in a battery. Thus, a magnesium secondary battery is a secondary battery that can cover disadvantages of the lithium secondary battery. Accordingly, importance will be attached to the development of a magnesium secondary battery using metallic magnesium (Mg) as an active material of an anode.

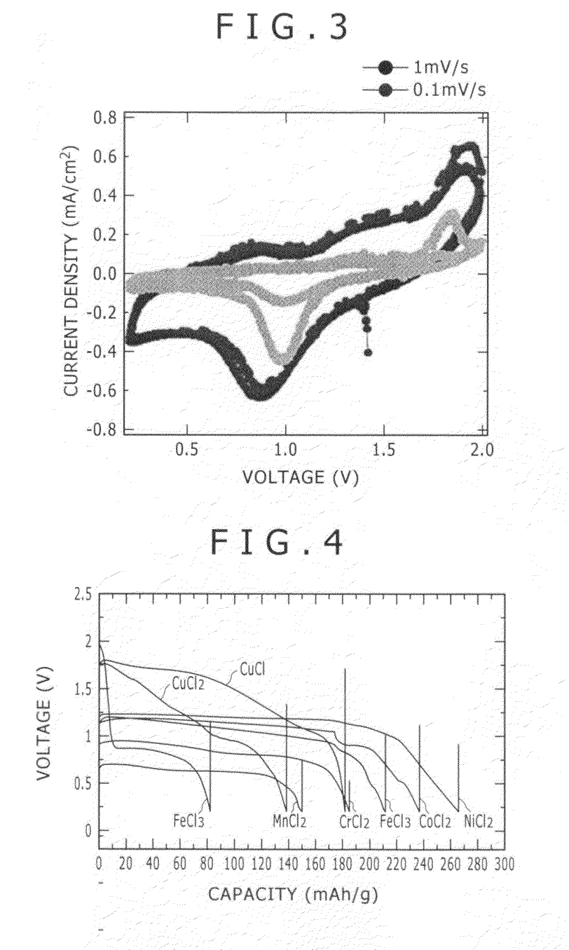

For example, Non-patent Document 1 (D. Aurbach et al., Nature, 407, p. 724-727 (2000) (p. 724-726, FIG. 3)) and Patent Document 1 (PCT Japanese Translation Patent Publication No. 2003-512704 (p. 12-19, FIG. 3)) report a magnesium secondary battery that can be cyclically charged and discharged 2000 times or more. This battery uses metallic magnesium as an active material of the anode and Chevrel compound represented by CuxMgyMo₆S₈, wherein “x” denotes 0 to 1 and “y” denotes 0 to 2, as an active material of the cathode. In addition, the battery uses, as an electrolytic solution, a solution of an electrolyte in an aprotic solvent such as tetrahydrofuran (THF), in which the electrolyte is represented by General Formula Mg(ZXₗR¹ₘR²ₙ)₂, wherein Z represents boron (B) or aluminum (Al); X represents chlorine (Cl) or bromine (Br); R¹ and R² each represent a hydrocarbon group; and “l”, “m”, and “n” satisfy the following condition: l+m+n=4.

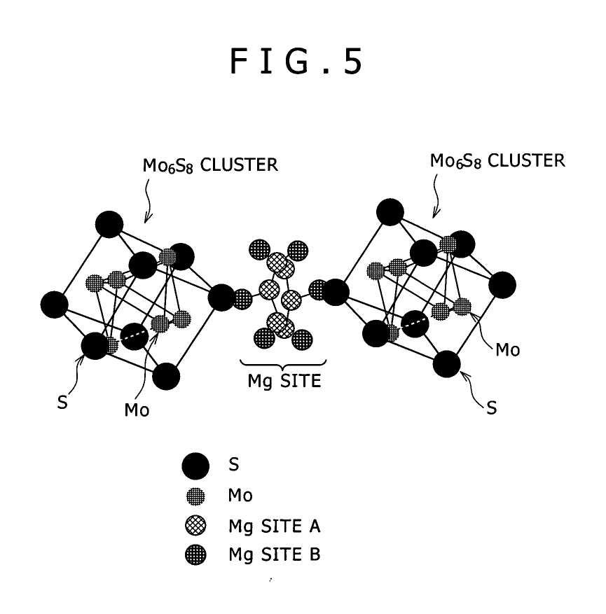

The Chevrel compound is a host-guest compound containing Mo₆S₈ as the host, and Cu²⁺ and Mg²⁺ as the guest. With reference to FIG. 5, Mo₆S₈ is present as clusters in which six Mo atoms are surrounded by eight S atoms, the six Mo atoms constitute a regular octahedron, and the eight S atoms constitute a cube. A multiplicity of the clusters is regularly stacked to form a basic structure of crystal. Cu²⁺ and Mg²⁺ are located in a channel region between two clusters and are weakly bound to Mo₆S₈.

Accordingly, Mg²⁺ can relatively easily migrate in the Chevrel compound, is immediately occluded into the Chevrel compound as the battery is discharged, and occluded Mg²⁺ is immediately released as the battery is charged. The amount of metal ions to be occluded into the Chevrel compound can largely vary depending on rearrangement of charges on Mo and S. An X-ray analysis has revealed that there are six sites A and six sites B between two Mo₆S₈ clusters, and Mg⁺ ions can be occluded into these sites. However, the Mg²⁺ ions may not occupy all the twelve sites concurrently.

### DISCLOSURE OF INVENTION

Unfortunately, the magnesium secondary battery reported in Non-patent Document 1 (D. Aurbach et al., Nature, 407, p. 724-727) and Patent Document 1 (PCT Japanese Translation Patent Publication No. 2003-512704) now available has one half or less as small energy capacity as that of the lithium ion secondary battery. This is because of its small energy capacity available per unit weight of the cathode active material. Even assuming that, for example, the Chevrel compound fully functions upon discharging and that the compound initially in a state represented by the chemical formula Mo₆S₈ receives two Mg²⁺ (formula weight: 24.3) ions and is converted into a state represented by the chemical formula Mg₂Mo₆S₈, Mo₆S₈ (formula weight: 832.2) of one chemical formula is required for receiving the two Mg²⁺ ions with a total formula weight of 48.6. Specifically, the Chevrel compound has merely about one-thirty-fourths as small energy capacity per unit weight as that of magnesium, and about 34 g of the Chevrel compound is required to collect energy corresponding to 1 g of magnesium.

Consequently, it is important to develop a cathode active material having a large energy capacity per unit weight, for effectively exploiting the characteristic properties of metallic magnesium as an anode active material having a large energy capacity per unit weight. In most of batteries as in this example, respective properties of the respective components including the anode active material, cathode active material, and electrolyte should be improved, and the properties of these components as a whole should be improved.

The present invention has been made to solve the above-mentioned problems, and an object thereof is to provide an electrochemical device which is configured to fully exploit excellent properties as an anode active material, such as large energy capacity, of a polyvalent metal such as metallic magnesium.

Specifically, the present invention relates to an electrochemical device which includes a first electrode, second electrode, and an electrolyte,

in which the electrochemical device is characterized by being so configured that:

the second electrode contains an active material that forms metal ions selected from magnesium ions, aluminum ions, and calcium ions as a result of oxidation;

the first electrode contains an active material that is a halide of at least one metal element selected from the group consisting of scandium (Sc), titanium (Ti), vanadium (V), chromium (Cr), manganese (Mn), iron (Fe), cobalt (Co), nickel (Ni), copper (Cu), and zinc (Zn); and

the metal ions are occluded into the first electrode.

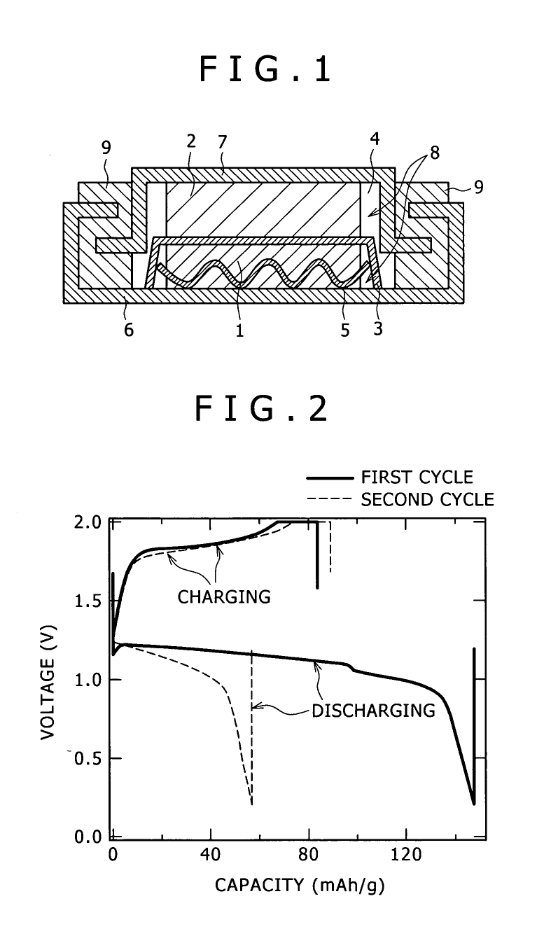

### BRIEF DESCRIPTION OF DRAWINGS

[FIG. 1] FIG. 1 is a cross-sectional view of a secondary battery according to an embodiment of the present invention.

[FIG. 2] FIG. 2 is a graph showing charging and discharging curves as measured for a magnesium secondary battery 10 according to Example 1 of the present invention.

[FIG. 3] FIG. 3 is a graph showing cyclic voltammetric (CV) curves as measured for the magnesium secondary battery 10 according to Example 1 of the present invention.

[FIG. 4] FIG. 4 is a graph showing measured discharging curves of different magnesium secondary batteries 10 according to Example 2 of the present invention.

[FIG. 5] FIG. 5 is an illustration showing the characteristic structure of the Chevrel compound in Non-patent Document 1.

### BEST MODES FOR CARRYING OUT THE INVENTION

In the present invention, the active material of the second electrode is desirably an elementary metal selected from magnesium, aluminum, and calcium, or an alloy containing any of these metals. It is desirable to use a pure metal in the second electrode in consideration of energy capacity alone, but an alloy is also desirable for improving other battery performance capabilities than energy capacity, such as stabilization of the second electrode against repeated cycles of charging and discharging.

Further, the metal ions are desirably magnesium ions. As has been described above, such a magnesium secondary battery using magnesium as an anode active material is advantageous in that it has a large energy capacity available per unit weight, is safe and easy to handle, and that magnesium is abundant in resources and is inexpensive.

The halogen element is desirably chlorine or fluorine. The halogen element constituting the halide preferably has a small atomic weight for constituting a battery having a large energy capacity available per unit weight. From this point, the halogen element is most desirably fluorine, followed by chlorine. However, fluorides are uneasy to handle chemically and are expensive. From these points, the halide is most desirably chloride.

The active material of the first electrode preferably has an average particle diameter of 1 nm or more and 100 μm or less, more preferably 1 to 1000 nm, and furthermore preferably 10 to 300 nm. The halide as the active material of the first electrode is preferably in the form of fine particles, and their average particle diameter is preferably minimized, because the surface area of the halide increases, and regions that can interact with the metal ions increase with a decreasing average particle diameter of the halide particles. The halide is particularly preferably in the form of nanosized fine particles having sizes on the order of nanometers.

In a preferred embodiment, the first electrode is composed of the active material of the first electrode mixed with an electroconductive material and a polymeric binder. As the active material of the first electrode is not electroconductive, the first electrode is desirably formed by adding the electroconductive material to the active material of the first electrode, and mixing and compounding them with the polymeric binder, in order to allow electrochemical reactions to proceed smoothly. The electroconductive material is not particularly limited but is preferably, for example, graphite powder and/or carbon fine particles. The polymeric binder is not particularly limited, as long as it can bind the active material of the first electrode and the electroconductive material, but is desirably, for example, poly(vinylidene fluoride) (PVdF).

In another preferred embodiment, the electrolyte is composed of an electrolytic solution or a solid electrolyte. Specific examples of them include the electrolytic solution reported typically in Non-patent Document 1 (PCT Japanese Translation Patent Publication No. 2003-512704). This electric solution is a solution of the electrolyte represented by the chemical formula Mg(AlCl₂EtBu)₂ in an aprotic solvent such as tetrahydrofuran (THF). In the chemical formula, “Et” represents ethyl group (—C₂H₅), and “Bu” represents butyl group (—C₄H₉) (hereinafter the same).

The electrochemical device is preferably configured as a battery. The battery may be configured as a primary battery but is preferably configured as a secondary battery that is rechargeable as a result of a reverse reaction. In contrast to the primary battery which is discarded after being used only once, the secondary battery can be used repeatedly, whereby resources can be utilized effectively, because the secondary battery can be charged after use and returned to a state before discharging by allowing a current to flow in a reversed direction to the direction of a current in discharging and thereby causing a reverse reaction to the discharging reaction.

An embodiment of the present invention will be illustrated in detail with reference to the attached drawings.

According to this embodiment, a secondary battery will be illustrated as an example of electrochemical devices according to the present invention.

FIG. 1 is a cross-sectional view of a secondary battery 10 according to this embodiment. With reference to FIG. 1, the secondary battery 10 is formed as a coin battery with a thin outer shape. The secondary battery 10 includes a cathode 1 as the first electrode, an anode 2 as the second electrode, and a separator 3 that separates these electrodes from each other. It also includes a cathode current collector 6, an anode current collector 7, and a battery chamber 8. The battery chamber 8 is surrounded by the cathode current collector 6 and the anode current collector 7 and filled with an electrolytic solution 4 as the electrolyte.

The cathode 1 is formed by compression bonding of a mixture to a cathode current collecting net 5. The mixture contains a cathode active material, graphite powder and/or carbon fine particles as the electroconductive material, and the polymeric binder. The cathode active material is composed of a halide of at least one metal element selected from the group consisting of scandium (Sc), titanium (Ti), vanadium (V), chromium (Cr), manganese (Mn), iron (Fe), cobalt (Co), nickel (Ni), copper (Cu) and zinc (Zn). The cathode current collecting net 5 formed typically from a stainless steel (according to Stainless Steel Association Standard; SAS). The cathode current collecting net 5 is arranged so as to be in contact with the cathode current collector 6. The polymeric binder is desirably added, for increasing the durability of the cathode 1, but the polymeric binder may be omitted for maximizing the energy available per unit weight and unit volume of the cathode 1.

The anode 2 is composed of, for example, elementary metal of magnesium, aluminum, or calcium in the form typically of a plate or sheet and is arranged so as to be in contact with the anode current collector 7. It is desirable to use a pure metal in the anode 2 for maximizing the energy capacity. However, an alloy may be used for improving other battery performance capabilities than energy capacity, such as stabilization of the anode 2 against repeated cycles of charging and discharging.

The separator 3 composed typically of polyethylene glycol is arranged between the cathode 1 and the anode 2 to avoid direct contact between the cathode 1 and the anode 2. The battery chamber 8 is surrounded by the cathode current collector 6 and the anode current collector 7 and is filled with the electrolytic solution 4. The electrolytic solution 4 is a solution of a suitable salt containing the metal ions in an aprotic solvent and is, for example, a solution of Mg(ACl₂EtBu)₂ in tetrahydrofuran (THF).

The cathode current collector 6 and the anode current collector 7 are each made typically of stainless steel (SAS). The battery chamber 8 is hermetically sealed with a gasket 9. The gasket 9 acts to prevent the electrolytic solution 4 from leakage and to electrically insulate the cathode 1 and the anode 2 from each other.

Upon discharging, the elementary metal of magnesium, aluminum, or calcium or an alloy thereof as the anode active material is oxidized in the anode 2 of the secondary battery 10 according typically to the following reaction formula:

Anode: Mg→Mg²⁺+2e⁻

to thereby release electrons through the anode current collector 7 to an external circuit. Magnesium ions, aluminum ions, or calcium ions as the metal ions are formed as a result of this reaction, are dissolved into the electrolytic solution 4, diffuse in the electrolytic solution 4, and migrate toward the cathode 1.

The metal ions migrated to the cathode 1 are trapped on a surface of the halide as the cathode active material and/or on inner surfaces of vacancies formed in the halide and are thereby occluded into the cathode 1. In this process, there occurs a reaction such as:

Cathode: Mg²⁺+CoCl₂+2e⁻→MgCl₂+Co

whereby the metal ions such as magnesium ions are stably occluded, cations of the metal element, such as Co²⁺ ions, are reduced to take electrons therein through the cathode current collecting net 5 and the cathode current collector 6 from the external circuit.

A halide such as cobalt(II) chloride (CoCl₂; formula weight 68.2) has a smaller compositional formula weight and a larger density than, for example, Mo₆S₈ used in Non-patent Document 1 (D. Aurbach et al., Nature, 407, p. 724-727). Consequently, a cathode active material having a smaller weight and a smaller volume than known materials is available to constitute the secondary battery 10 by using a halide such as cobalt(II) chloride as the cathode active material. Thus, the resulting secondary battery can have a larger energy capacity available per unit weight and unit volume without adversely affecting the characteristic properties of magnesium, i.e., a large energy capacity available per unit weight.

### EXAMPLES

Several examples according to the present invention will be illustrated below.

### Example 1

A coin magnesium secondary battery 10 illustrated in FIG. 1 was prepared using metallic magnesium as an anode active material, and cobalt(II) chloride (CoCl₂) as a cathode active material.

### <Preparation of Cathode 1>

Initially, a mixture was prepared by pulverizing cobalt(II) chloride (CoCl₂; product from Sigma-Aldrich Co.) in a mortar, adding small-sized graphite as a carbon electroconductive material thereto, and mixing them thoroughly. The graphite is a product from Timcal Japan Co., Ltd. under the trade name of “KS6” and has an average particle diameter of 6 μm. The mixture contains cobalt(II) chloride and KS6 in a weight ratio of 1:1. The mixture was subjected to compression bonding to a cathode current collecting net 5 made of stainless steel (SAS) and thereby yielded a cathode 1 in the form of a pellet.

In this example, a polymeric binder is omitted, for maximizing the energy available per unit weight and unit volume of the cathode 1. However, a polymeric binder is desirably used for increasing the durability of the cathode 1. In this case, a cathode 1 in the form of a pellet may be formed by thoroughly mixing cobalt(II) chloride and KS6 with a polymeric binder such as poly(vinylidene fluoride) (PVdF), adding a solvent that dissolves the polymeric binder, such as N-methylpyrrolidone (NMP), to yield a slurry, vaporizing the solvent in vacuo from the slurry, thoroughly pulverizing the solidified mixture, and compression-bonding the pulverized mixture to a cathode current collecting net 5.

### <Preparation of Secondary Battery 10>

A secondary battery 10 was prepared in which a separator 3 of polyethylene glycol was arranged between the cathode 1 and an anode 2 of a metallic magnesium plate so as to avoid direct contact between the cathode 1 and the anode 2; and a battery chamber 8 surrounded by a cathode current collector 6 and an anode current collector 7 was filled with an electrolytic solution 4. These current collectors are made of stainless steel (SAS). As the electrolytic solution 4, a solution of Mg(ACl₂EtBu)₂ in tetrahydrofuran (THF) was prepared to a concentration of 0.25 mol/l, and a total of 150 μL of the solution was charged and divided into two equal portions (each 75 μL) by the separator 3.

### <Measurement of Charging and Discharging of Secondary Battery 10>

The secondary battery 10 prepared as mentioned above was examined for charging and discharging performance at room temperature. Discharging was performed at a constant current of 0.5 mA until the voltage dropped to 0.2 V. Charging was performed at a constant current of 0.5 mA until the voltage reached 2 V and thereafter the charging current reached 0.1 mA at a constant voltage of 2 V. Measurement of discharging was carried out first. Incidentally, it was verified that the battery immediately after preparation did not decrease in voltage when left in the open circuit state and was stable in voltage.

FIG. 2 is a graph showing the results of measurements of charging and discharging of the secondary battery 10. FIG. 2 demonstrates that discharging in the first cycle takes place at a constant voltage in the neighborhood of 1.2 V. Surely, this is not due to the graphite powder as the electroconductive material of the cathode 1 as confirmed in preliminary experiments. Discharging in the first cycle suggests a battery reaction. Discharging in the second and subsequent cycles, however, show a capacity about one-thirds of that in the first cycle. Discharging in the third cycle gives a capacity similar to that in the second cycle.

The battery shows a decreased capacity probably because the charging voltage of 2 V is insufficient. However, charging at a voltage of 2 V or more was not performed in this experiment, because if charging is performed at a voltage of 2 V or more, the electrolytic solution used herein (solution of Mg(AlCl₂EtBu)₂ in THF) may decompose. It is probably possible to increase the discharging capacity in the second and subsequent cycles by using an electrolytic solution having a greater potential window.

### <Cyclic Voltammetry (CV) of Secondary Battery 10>

Cyclic voltammetry (CV) of the secondary battery 10 was performed at room temperature. The cycle of open circuit state (OCV) →0.2 V→2.0 V→OCV was repeated twice at 0.1 and 1 mV/s. Measurement was carried out with the voltage not exceeding 2.0 V because there was the possibility of the electrolytic solution used herein decomposing.

FIG. 3 is a graph showing the results of cyclic voltammetry of the secondary battery 10. With reference to FIG. 3, there is a peak in the neighborhood of 0.9 V which is presumably due to reduction of the cathode active material. There is also a peak in the neighborhood of 1.9 V which is presumably due to oxidation of the cathode active material. The results in FIGS. 2 and 3 demonstrate that the secondary battery 10 undergoes charging and discharging reactions as a secondary battery.

### Example 2

FIG. 4 is a graph showing measured discharging curves of different magnesium secondary batteries 10 prepared by using other chlorides as the cathode active material. FIG. 4 also shows the measured discharging curve of CoCl₂ used in Example 1 for comparison. Materials used herein are CuCl, CuCl₂, NiCl₂, FeCl₂, FeCl₃, CrCl₂, and MnCl₂. These materials used herein are all products from Sigma-Aldrich Co., and preparation and measurement of the batteries were performed in the same manner as in Example 1. FIG. 4 demonstrates that many chloride materials are usable as the cathode active material of the magnesium secondary battery, of which NiCl₂, CoCl₂, FeCl₂, CrCl₂, and CuCl₂ are preferred for their high current capacities.

A reference (J. Electrochem. Soc., 149, p. 627-634 (2002)) reports a lithium ion secondary battery using cobalt(II) oxide (CoO) as a cathode active material. It is reported that the lithium ion secondary battery according to this system shows a low capacity and/or deteriorated cycling performance when the cobalt oxide has a large particle diameter, as in Examples 1 and 2 according to the present invention. It is also reported that charging and discharging are conducted with low efficiency unless discharging is performed at a sufficiently low voltage and charging is performed at a sufficiently high voltage.

There is a high possibility that the electrolytic solution 4 used herein is not examined under optimum charging conditions, because the electrolytic solution 4 surely decomposes at 2.5 V or more. In addition, the cathode availability is expected to be improved to thereby yield larger voltage and capacity if the size of the cathode active material used herein is optimized and other materials constituting the cathode are optimized.

According to the present invention, a larger capacity than present lithium ion secondary batteries is available when a cathode material having a smaller size is available, the structure of the cathode is optimized, and an electrolyte/electrolytic solution with large potential window is developed.

It is also expected that a magnesium secondary battery having battery properties superior to those of lithium ion secondary batteries will be obtained in future, because the magnesium secondary battery has a theoretical capacity equivalent to that of the lithium ion secondary battery when the two batteries use the same cathode material, and magnesium has a larger capacity per unit volume than that of lithium.

While the present invention has been described above with reference to embodiments and examples, it will be variously modified within the scope and spirit thereof.

For example, the electrochemical device (suitable as a primary or secondary battery) according to the present invention may adequately vary in shape, configuration or structure, and material within the scope of the present invention.

The foregoing description is concerned about examples that employ magnesium ions as the metal ions; however, such ions may be replaced by aluminum ions or calcium ions.

The electrochemical device according to the present invention provides excellent characteristic properties when configured, for example, as a battery. This is because the electrochemical device includes a first electrode, a second electrode, and an electrolyte, and is so configured that:

the second electrode contains an active material that forms metal ions selected from magnesium ions, aluminum ions, and calcium ions as a result of oxidation,

the first electrode contains an active material that is a halide of at least one metal element selected from the group consisting of scandium (Sc), titanium (Ti), vanadium (V), chromium (Cr), manganese (Mn), iron (Fe), cobalt (Co), nickel (Ni), copper (Cu), and zinc (Zn), and

the metal ions are occluded into the first electrode.

Specifically, the second electrode undergoes a reaction of oxidizing its active material to form the metal ions. This reaction is a reaction accompanied with a large enthalpy change and can give a large electromotive force, because magnesium, aluminum, and calcium are metals having large ionization potentials. In addition, the active material of the second electrode gives a large quantity of electricity per unit weight, because the magnesium ion, the aluminum ion, and the calcium ion have small formula weights per unit change of 12.15, 9.0, and 20.0, respectively. As a result, a large energy capacity is available per unit weight of the active material of the second electrode.

The resulting metal ions diffuse in the electrolyte, migrate toward the first electrode, and are trapped and occluded to the surface of the halide as the active material of the first electrode in broad meaning, i.e., trapped by a surface of the halide and inner surfaces of vacancies within the halide. The term “vacancies” used herein refers typically to cavities or voids formed inside an aggregate of fine crystals of the halide. In the halide, fine crystals of the halide two-dimensionally and three-dimensionally aggregate to form an aggregate including cavities of various shapes, and these cavities function as passages typically for the metal ions.

The halide has a smaller compositional formula weight and a higher density than known cathode active materials (for example, Mo₆S₈ in Non-patent Document 1) of magnesium batteries, because most of metal elements for constituting the halide are transition elements whose 3 d shell will be occupied. Accordingly, the halide provides the first electrode active material having a smaller weight and a smaller volume than known equivalents, and this first electrode active material constitutes the battery. The resulting battery has a large energy capacity available per unit weight and unit volume, without adversely affecting the characteristic properties of the active material of the second electrode, i.e., a large energy capacity available per unit weight.

### INDUSTRIAL APPLICABILITY

The electrochemical device according to the present invention provides, for example, a magnesium secondary battery having such a configuration as to sufficiently exploit large energy capacity and other excellent properties, as an anode active material, of a polyvalent metal such as metallic magnesium. This contributes to reduction in size and weight, and increased portability of small electronic equipment and contributes to improved convenience and lower cost thereof.

What is claimed is:

1. An electrochemical device, comprising a first electrode, a second electrode, and an electrolyte,
wherein the second electrode comprises an active material that forms, as a result of oxidation, metal ions selected from a group consisting of magnesium ions, aluminum ions, and calcium ions;
wherein the first electrode contains an active material that is a halide of at least one metal element selected from the group consisting of scandium (Sc), titanium (Ti), vanadium (V), chromium (Cr), manganese (Mn), iron (Fe), cobalt (Co), nickel (Ni), copper (Cu), and zinc (Zn); and
wherein the metal ions are occluded into the first electrode.

2. The electrochemical device according to claim 1, wherein the active material of the second electrode is an elementary metal selected from a group consisting of magnesium, aluminum, and calcium, or is an alloy comprising any of these metals.

3. The electrochemical device according to claim 1, wherein the metal ions are magnesium ions.

4. The electrochemical device according to claim 1, wherein the halide is one of chlorine and fluorine.

5. The electrochemical device according to claim 1, wherein the halide forms at least a portion of particles having an average particle diameter of 1 nm or more and 100 μm or less.

6. The electrochemical device according to claim 1, wherein the first electrode comprises the active material mixed with an electroconductive material and a polymeric binder.

7. The electrochemical device according to claim 1, wherein the electrolyte comprises one of an electrolytic solution and a solid electrolyte.

8. The electrochemical device according to claim 1, wherein the electrochemical device is configured as a battery.

9. The electrochemical device according to claim 8, wherein the electrochemical device is configured as a secondary battery that is rechargeable as a result of a reverse reaction.
